(19) United States
(12) Patent Application Publication
(10) Pub. No.: US 2020/0160272 A1
(43) Pub. Date: May 21, 2020

(54) HUMAN RESOURCE CAPITAL RELOCATION SYSTEM

(71) Applicant: ADP, LLC, Roseland, NJ (US)

(72) Inventors: Kurt D. Newman, Columbus, GA (US); Debashis Ghosh, Charlotte, NC (US); Ramsay Cole, Brooklyn, NY (US)

(21) Appl. No.: 16/193,251

(22) Filed: Nov. 16, 2018

(51) Int. Cl. G06Q 10/10; G06F 17/30; G06Q 10/06; G06Q 10/04

(52) U.S. Cl. CPC G06Q 10/105; G06F 17/30241; G06F 17/30312; G06Q 10/04; G06Q 10/067

(57) ABSTRACT

A method, an apparatus, and a computer program product for digitally presenting a competitive human resources migration model for an organization. A computer system identifies human resources data regarding employees of a set of benchmark organizations. The human resources data comprises employee names and job types. The computer system indexes the human resources data according to job types. The computer system determines a set of geographic distribution trends for each of the job types. The set of geographic distribution trends is determined based on employee names of the employees. The computer system determines a competitive human resources migration model for the organization based on an effect of the set of geographic distribution trends on business metrics for the set of benchmark organizations. The computer system digitally presents the competitive human resources migration model for the organization.

### BACKGROUND INFORMATION

### 1. Field

The present disclosure relates generally to an improved computer system and, in particular, to a method and apparatus for accessing information in a computer system. Still more particularly, the present disclosure relates to a method, a system, and a computer program product for determining and presenting a competitive human resources migration model for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As yet another example, an information system may be used to hire new employees, assign employees to projects, perform reviews for employees, and other suitable operations for the organization. As another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, understanding how the outsourcing of employees affects business metrics may be desirable when performing operations such as identifying new hires, selecting teams for projects, and other operations in the organization. However, relevant information often cannot be determined for when formulating relocation strategies of human resource capital. Therefore, relevant information is often excluded from the analysis and performance of the operation. Furthermore, identifying appropriate relocation strategies for companies of a particular size and industry may take more time than desired in an information system.

Therefore, it would be desirable to have a method and apparatus that take into account at least some of the issues discussed above, as well as other possible issues. For example, it would be desirable to have a method and apparatus that overcome the technical problem of presenting a potentially competitive human resource migration model for an organization.

### SUMMARY

An embodiment of the present disclosure provides a method for digitally presenting a competitive human resources migration model for an organization. A computer system identifies human resources data regarding employees of a set of benchmark organizations. The human resources data comprises employee names and job types. The computer system indexes the human resources data according to job types. The computer system determines a set of geographic distribution trends for each of the job types. The set of geographic distribution trends is determined based on employee names of the employees. The computer system determines a competitive human resources migration model for the organization based on an effect of the set of geographic distribution trends on business metrics for the set of benchmark organizations. The computer system digitally presents the competitive human resources migration model for the organization.

Another embodiment of the present disclosure provides a computer system comprising a hardware processor, a display system, and a migration modeler in communication with the hardware processor and the display system. A outsourcing modeler identifies human resources data regarding employees of a set of benchmark organizations. The human resources data comprises employee names and job types. The outsourcing modeler indexes the human resources data according to job types. The outsourcing modeler determines a set of geographic distribution trends for each of the job types. The set of geographic distribution trends is determined based on employee names of the employees. The outsourcing modeler determines a competitive human resources migration model for the organization based on an effect of the set of geographic distribution trends on business metrics for the set of benchmark organizations. The outsourcing modeler digitally presents the competitive human resources migration model for the organization.

Yet another embodiment of the present disclosure provides a computer program product for digitally presenting a competitive human resources migration model for an organization. The computer program product comprises a non-transitory computer readable storage media and program code, stored on the computer readable storage media. The program code includes code for identifying human resources data regarding employees of a set of benchmark organizations. The human resources data comprises employee name data and job type data. The program code includes code for indexing the human resources data according to the job type data. The program code includes code for determining a set of geographic distribution trends for each job type. Whe set of geographic distribution trends is determined based on the surname data of the employees. The program code includes code for determining a competitive human resources migration model for the organization based on an effect of the set of geographic distribution trends on business metrics for a set of benchmark organizations. The program code includes code for digitally presenting the competitive human resources migration model for the organization.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of a human resources migration environment in accordance with an illustrative embodiment;

FIG. 2 is a block diagram of a data flow for determining a set of benchmark organizations within a human resource modeling system in accordance with an illustrative embodiment;

FIG. 3 is a block diagram of a data flow for determining employee migration data within a human resource modeling system in accordance with an illustrative embodiment;

FIG. 4 is a flowchart of a process for digitally presenting a competitive human resources migration model in accordance with an illustrative embodiment; and

FIG. 5 is a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about the effects of employee relocations on business metrics when performing certain operations. Furthermore, identifying appropriate relocation strategies for companies of a particular size and industry may also be desirable. The illustrative embodiments also recognize and take into account that searching information systems for successful relocation strategies, and identifying the effects of the strategies, may be more cumbersome and time-consuming than desirable.

The illustrative embodiments also recognize and take into account that digitally presenting a potentially competitive human resources migration model for an organization may facilitate accessing information about appropriate relocation strategies when performing operations for an organization. The illustrative embodiments also recognize and take into account that identifying a potentially competitive human resources migration model may still be more difficult than desired.

Thus, the illustrative embodiments provide a method and apparatus for digitally presenting a competitive human resources migration model for an organization. In one illustrative example, a computer system determines employee migration data for benchmark organizations. The computer system determines migration metrics from the employee migration data. The computer system determines migration events for the benchmark organizations based on subsets of the migration metrics. The computer system determines an effect of the migration events on business metrics for the benchmark organizations. The computer system determines the competitive human resources migration model for the organization based on the effect on the business metrics. The computer system digitally presents the competitive human resources migration model for the organization.

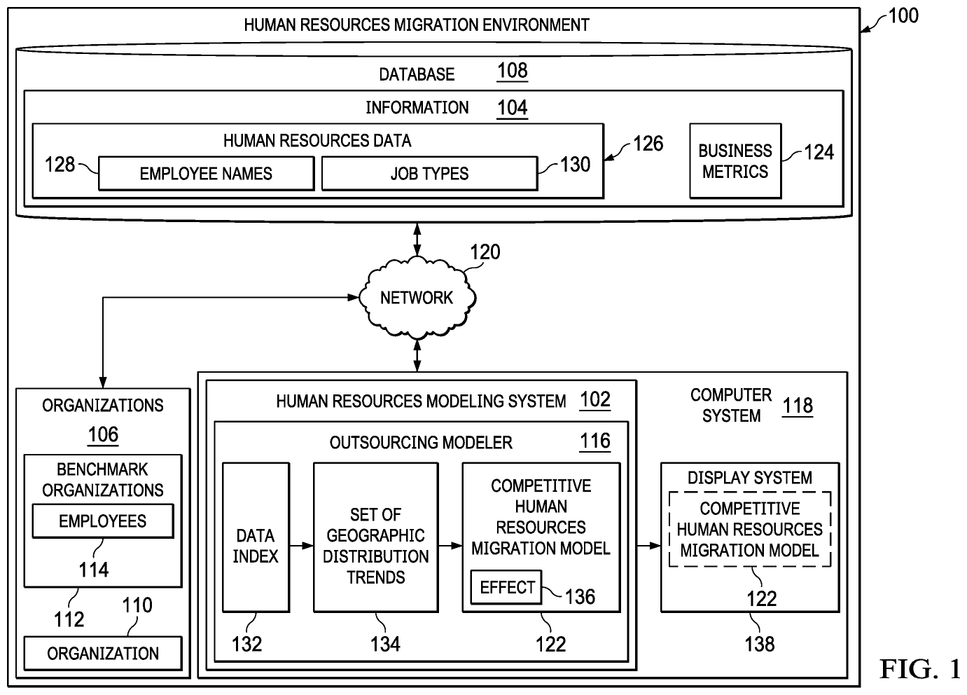

With reference now to the figures and, in particular, with reference to FIG. 1, a block diagram of a human resources migration environment is depicted in accordance with an illustrative embodiment. As depicted, human resources migration environment 100 includes human resources modeling system 102.

Human resources modeling system 102 may take different forms. For example, human resources modeling system 102 may be selected from one of an employee information system, a research information system, a sales information system, an accounting system, a payroll system, a human resources system, or some other type of information system that stores and provides access to information 104.

Information 104 can include information about organizations 106. Information 104 may include, for example, at least one of information about people, products, research, product analysis, business plans, financials, or other information relating to organizations 106. As depicted, information 104 is stored on database 108.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, organizations 106 include organization 110 and benchmark organizations 112. Each of organization 110 and benchmark organizations 112 may be, for example, a corporation, a partnership, a charitable organization, a city, a government agency, or some other suitable type of organization. As depicted, benchmark organizations 112 includes employees 114.

As depicted, employees 114 are people who are employed by or associated with organizations 108. For example, employees 114 can include at least one of employees, administrators, managers, supervisors, and third parties associated with organizations 108.

In this illustrative example, human resources modeling system 102 includes a number of different components. As depicted, human resources modeling system 102 includes outsourcing modeler 116. Outsourcing modeler 116 may be implemented in computer system 118.

Computer system 118 is a physical hardware system and includes one or more data processing systems. When more than one data processing system is present, those data processing systems may be in communication with each other using a communications medium. The communications medium may be a network, such as network 120. The data processing systems may be selected from at least one of a computer, a server computer, a workstation, a tablet computer, a laptop computer, a mobile phone, or some other suitable data processing system.

In this illustrative example, outsourcing modeler 116 generates competitive human resources migration model 122. Competitive human resources migration model 122 is a suggested human resource capital outsourcing strategy for organization 110 based on information 104 about benchmark organizations 112.

By generating competitive human resources migration model 122, outsourcing modeler 116 enables the performance of operations by organization 110 that may promote desired changes to business metrics 124 of organization 110. For example, competitive human resources migration model 122 allows organization 110 to perform operations based on changes to business metrics 124 of benchmark organizations 112.

Outsourcing modeler 116 may be implemented in software, hardware, firmware, or a combination thereof. When software is used, the operations performed by outsourcing modeler 116 may be implemented in program code configured to run on hardware, such as a processor unit. When firmware is used, the operations performed by outsourcing modeler 116 may be implemented in program code and data and stored in persistent memory to run on a processor unit. When hardware is employed, the hardware may include circuits that operate to perform the operations in outsourcing modeler 116.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Outsourcing modeler 116 provides a method for digitally presenting competitive human resources migration model 122 for organization 110. As depicted, information 104 includes human resources data 126. As used herein, human resources data 126 is information used to perform human resources operations for employees 114. For example, human resources data 126 may include data that is used to process payroll to generate paychecks for employees 114 of benchmark organizations 112. Additionally, human resources data 126 may include data that is used by human resources departments of benchmark organizations 112 to maintain benefits and other records about employees 114. As depicted, human resources data 126 comprises employee names 128 and job types 130.

Employee names 128 are names of employees 114. Employee names 128 can include, for example, but not limited to, a first name, a middle name, a last name, and combinations thereof for one or more of employees 114 of benchmark organizations 112.

Human resources data 126 includes job types 130. Job types 130 are data that indicate a category of employees 114 based on the duties or responsibilities performed for benchmark organizations 112. For example, job types 130 may include data, such as, but not limited to, a specific data entry of indicating a job title, a position of employees 114 in a reporting hierarchy of benchmark organization 112, a description of the duties or responsibilities of employees 114, a Standard Occupational Classification (SOC) of employees 114, a manager level description, and an Employee Information Report (EEO-1) of employees 114, as well as other suitable types of data.

Outsourcing modeler 116 indexes human resources data 126 according to job types 130. Data index 132 is an indexing tool provided by outsourcing modeler 116 for indexing human resources data 124 by job types 130. In this manner, outsourcing modeler 116 enables searching human resources data 126 by job types 130.

Outsourcing modeler 116 determines set of geographic distribution trends 134 for each of job types 130. As used herein, a “geographic distribution” is a distribution of a particular one of job types 130 across one or more geographic locations. A “geographic distribution trend” is a change in the geographic distribution of a particular one of job types 130 by one or more of benchmark organizations 112.

Set of geographic distribution trends 134 is determined based on employee names 128. For example, by identifying one or more of a geographic or ethnic origin of employee names 128, as well as an incidence of geographic or ethnic origin for each of job types 130, outsourcing modeler 116 can identify which of job types 130 that benchmark organizations 112 has outsourced to different geographic locations.

Outsourcing modeler 116 determines a competitive human resources migration model 122 for organization 110. Competitive human resources migration model 122 is a suggested human capital resources relocation strategy for organization 110 based on changes in business metrics 124 attributed to set of geographic distribution trends 134 of benchmark organizations 112.

In an illustrative example, outsourcing modeler 116 determines competitive human resources migration model 122 based on effect 136 of set of geographic distribution trends 134 on business metrics 124 for the set of benchmark organizations 112. The effect can be a change to one or more of business metrics 124. Based on effect 136 on business metrics 124, outsourcing modeler 116 determines competitive human resources migration model 118 for organization 106.

Outsourcing modeler 116 then digitally presents competitive human resources migration model 122 for organization 110. In this illustrative example, computer system 118 can display competitive human resources migration model 122 on display system 138. In this illustrative example, display system 138 can be a group of display devices. A display device in display system 138 may be selected from one of a liquid crystal display (LCD), a light emitting diode (LED) display, an organic light emitting diode (OLED) display, and other suitable types of display devices. An operator may interact with competitive human resources migration model 122 through user input to a graphical user interface generated by a user input device, such as, for example, a mouse, a keyboard, a trackball, a touchscreen, a stylus, or some other suitable type of input device.

By determining competitive human resources migration model 122, outsourcing modeler 116 enables more efficient performance of operations for organization 110. For example, organization 110 can perform operations, such as, but not limited to, at least one of hiring, benefits administration, payroll, performance reviews, forming teams for new products, assigning research projects, or other suitable operations consistent with competitive human resources migration model 122.

Operations that are performed consistent with competitive human resources migration model 122 allows organization 110 to implement a human capital resources outsourcing strategy based on changes in business metrics 124 attributed to set of geographic distribution trends 134 of benchmark organizations 112. For example, competitive human resources migration model 122 allows organization 106 to perform operations in a manner that is consistent with the human capital resources outsourcing strategies of benchmark organizations 112 based on effects 136 of set of geographic distribution trends 134 on business metrics 124.

In this illustrative example, human resources modeling system 102 digitally presents competitive human resources migration model 122 for organization 110. Outsourcing modeler 116 identifies human resources data 126 regarding employees 114 of a set of benchmark organizations 112. Human resources data 126 comprises employee names 128 and job types 130. Outsourcing modeler 116 indexes human resources data 126 according to job types 130. Outsourcing modeler 116 determines set of geographic distribution trends 134 for each of job types 130. Set of geographic distribution trends 134 is determined based on employee names 128 of employees 114. Outsourcing modeler 116 determines competitive human resources migration model 122 for organization 110 based on effect 136 of set of geographic distribution trends 134 on business metrics 124 for the set of benchmark organizations 112. Outsourcing modeler 116 digitally presents competitive human resources migration model 122 for organization 110.

The illustrative example in FIG. 1 and the examples in the other subsequent figures provide one or more technical solutions to overcome a technical problem of determining a competitive human resources capital relocation strategy for an organization that make the performance of operations for an organization more cumbersome and time-consuming than desired. For example, when organization 110 performs operations consistent with competitive human resources migration model 122, organization 110 implements a human capital resources relocation strategy in a manner that is consistent with set of geographic distribution trends 134 of benchmark organizations 112 based on changes in business metrics 124 attributed to set of geographic distribution trends 134 of benchmark organizations 112.

In this manner, the use of human resources modeling system 102 has a technical effect of determining competitive human resources migration model 122 based on set of geographic distribution trends 134 of benchmark organizations 112, thereby reducing time, effort, or both in the performance of operations for organization 110. In this manner, operations performed for organization 110 may be performed more efficiently as compared to currently used systems that do not include human resources modeling system 102. For example, operations such as, but not limited to, at least one of hiring, benefits administration, payroll, performance reviews, forming teams for new products, assigning research projects, or other suitable operations for organization 110, performed consistently with competitive human resources migration model 122 allows organization 110 to implement a human capital resources relocation strategy based on changes in business metrics 124 attributed to set of geographic distribution trends 134 of benchmark organizations 112.

As a result, computer system 118 operates as a special purpose computer system in which human resources modeling system 102 in computer system 118 enables outsourcing modeler 116 to determine and digitally present competitive human resources migration model 122 for organization 110. Outsourcing modeler 116 identifies human resources data 126 regarding employees 114 of a set of benchmark organizations 112. Human resources data 126 comprises employee names 128 and job types 130. Outsourcing modeler 116 indexes human resources data 126 according to job types 130. Outsourcing modeler 116 determines set of geographic distribution trends 134 for each of job types 130. The set of geographic distribution trends 134 is determined based on employee names 128 of employees 114. Outsourcing modeler 116 determines competitive human resources migration model 122 for organization 110 based on effect 136 of set of geographic distribution trends 134 on business metrics 124 for set of benchmark organizations 112. Outsourcing modeler 116 digitally presents competitive human resources migration model 122 for organization 110 on display system 138.

When competitive human resources migration model 122 is determined in this manner, competitive human resources migration model 122 may be relied upon to perform operations for organization 110. Operations can be performed in a manner that is consistent with set of geographic distribution trends 134 of benchmark organizations 112 based on changes in business metrics 124 attributed to set of geographic distribution trends 134 of benchmark organizations 112.

Thus, human resource modeling system 102 transforms computer system 118 into a special purpose computer system as compared to currently available general computer systems that do not have human resource modeling system 102. Currently used general computer systems do not reduce the time or effort needed to determine competitive human resources migration model 122 based on set of geographic distribution trends 134 and business metrics 124 of benchmark organizations 112.

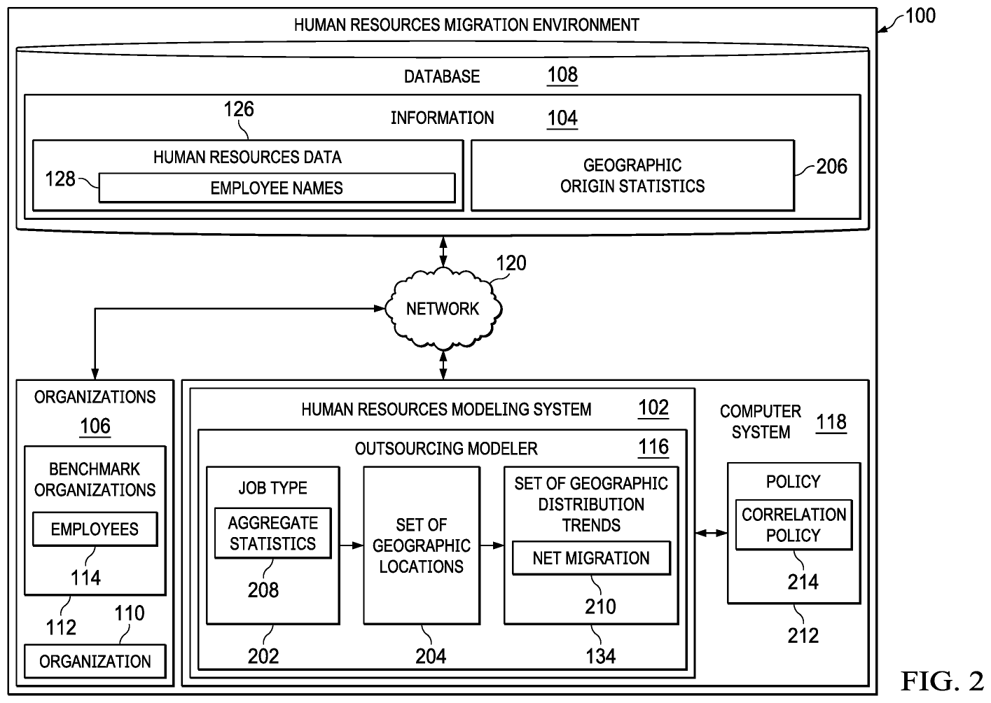

With reference next to FIG. 2, a block diagram of a data flow for determining a set of benchmark organizations within a human resource modeling system is depicted in accordance with an illustrative embodiment. As depicted, human resources modeling system 102 is human resources modeling system 102 of FIG. 1.

In an illustrative example, outsourcing modeler 116 determines set of geographic distribution trends 134 for job type 202. Job type 202 is an example of one of job types 130, shown in block form in FIG. 1.

In this illustrative example, outsourcing modeler 116 predicts set of geographic locations 204 for job type 202 based on employee names 128 of employees 114 of a set of benchmark organizations 112. In this illustrative example, outsourcing modeler 116 predicts the set of geographic locations 204 by identifying a set of geographic origin statistics 206 for one of each employee names 128. The set of geographic origin statistics 206 can include at least one of a population incidence of employee names 128 in each of set of geographic locations 204, a population frequency of employee names 128 in each of set of geographic locations 204, and an incidence ranking of employee names 128 in each of set of geographic locations 204.

In an illustrative example, outsourcing modeler 116 aggregates the set of geographic origin statistics 206 within job type 202. Aggregate statistics 208 are geographic origin statistics 206 for employee names 128 for employees 114 aggregated across job type 202. Outsourcing modeler 116 can determine similar aggregate statistics for each of job types 130, shown in block form in FIG. 1.

Outsourcing modeler 116 predicts set of geographic locations 204 for job type 202 based on aggregated statistics 208 for job type 202. In this manner, outsourcing modeler 116 is able to predict geographic locations to which benchmark organizations 112 have outsourced job type 202.

Outsourcing modeler 116 determines set of geographic distribution trends 134 for job type 202. In one illustrative example, human resources data 126 can indicate a first number of employees 114 for benchmark organizations 112 that migrate into set of geographic locations 204 over a time period. Human resources data 126 can indicate a second number of employees 114 for benchmark organizations 112 that migrate away from set of geographic locations 204 over the time period. From this data, outsourcing modeler 116 determines net migration 210 of employees 114 for benchmark organizations 112 in set of geographic locations 204 over the time period.

In an illustrative example, outsourcing modeler 116 determines effect 136 of FIG. 1 of set of geographic distribution trends 134 on business metrics 124 for set of benchmark organizations 112. In this illustrative example, outsourcing modeler 116 correlates business metrics 124 for benchmark organizations 112 with set of geographic distribution trends 134 using one or more of policy 212. In this illustrative example, policy 212 includes one or more rules that are used to determines an effect of set of geographic distribution trends 134 on business metrics 124 of FIG. 1 for benchmark organizations 112. Policy 212 also may include data used to apply one or more rules. As depicted, policy 212 includes correlation policy 214.

In an illustrative example, correlation policy 214 is a policy that uses descriptive statistics to determine effect 136. The descriptive statistics determine effect 136 by examining financial indicators in business metrics 124 indicating an immediate response to set of geographic distribution trends 134 in terms of financial growth/efficiencies of benchmark organizations 112, as reflected in business metrics 124.

In an illustrative example, correlation policy 214 is a policy that uses linear regression to determine effect 136. The linear regression uses business metrics 124 for previous time periods as lagged independent variables to determine effect 136 for a current time period. The linear regression determines effect 136 as a relationship between set of geographic distribution trends 134 in previous time periods and the subsequent changes to business metrics 124. The changes to business metrics 124 can include, for example, but not limited to, changes in revenue, stock price, profit, and operating expenses.

In an illustrative example, correlation policy 214 is a policy that uses vector auto-regression to determine effect 136. The vector auto-regression captures the linear interdependencies of set of geographic distribution trends 134 and other relevant events over time periods, wherein each of the variables is represented as an equation explaining their evolution based on its own lagged values and the lagged values of the other model variables. The vector auto-regression allows outsourcing modeler 116 to determine how effects 136 of set of geographic distribution trends 134 are evolving with other events that may have an effect on business metrics 124.

In an illustrative example, correlation policy 214 is a policy that uses impulse/response to determine effect 136. Impulse/response allows outsourcing modeler 116 to determine whether set of geographic distribution trends 134 produced a lasting effect to business metrics 124, or whether business metrics 124 quickly returned to their pre-migration mean.

In an illustrative example, outsourcing modeler 116 determines effect 136 on business metrics 124. In this illustrative example, effect 136 can be, for example, but not limited to, a change in a stock price of benchmark organizations 112, a change in a revenue of benchmark organizations 112, a change in operating expenses of benchmark organizations 112, and a change in a gross profit of benchmark organizations 112, as well as other suitable effects.

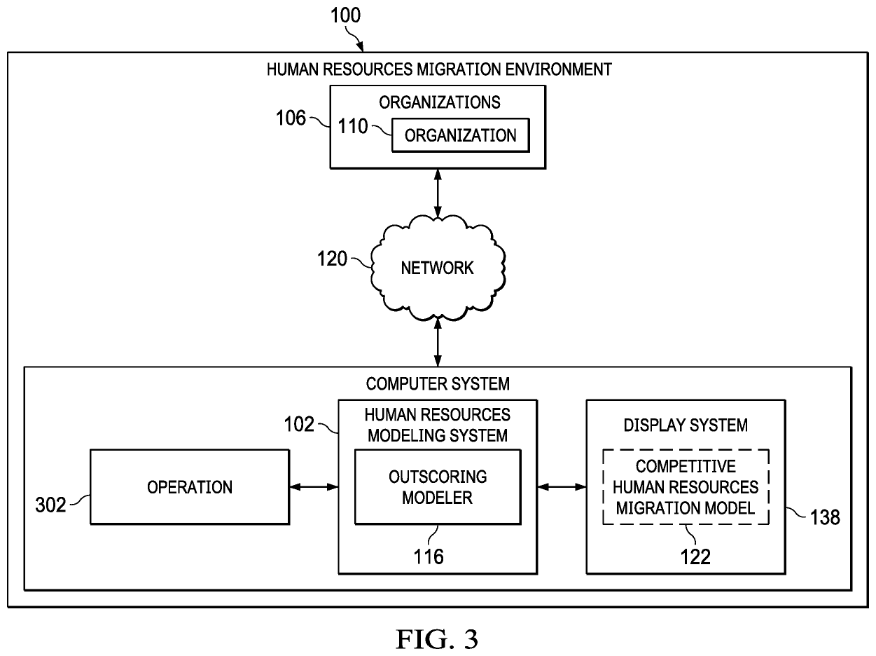

With reference next to FIG. 3, a block diagram of a data flow for determining employee migration data within a human resource modeling system is depicted in accordance with an illustrative embodiment. As depicted, human resources modeling system 102 is human resources modeling system 102 of FIG. 1.

In this illustrative example, human resources modeling system 102 performs operation 302 for organization 110 based on competitive human resources migration model 122 for organization 110. Operation 302 can be, for example, but not limited to, at least one of job type relocation, outsourcing, hiring, benefits administration, payroll, performance reviews, forming teams for new products, assigning research projects, or other suitable operations for organization 110. Operation 302 is enabled based on competitive human resources migration model 122.

The illustration of human resources modeling system 102 in FIG. 1 and the different components and examples of implementations in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

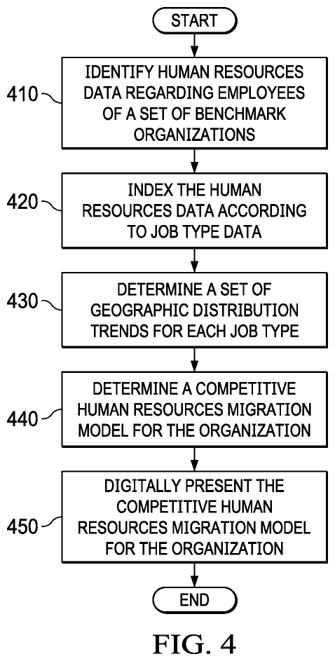

With reference next to FIG. 4, a flowchart of a process for digitally presenting a competitive human resources migration model is depicted in accordance with an illustrative embodiment. The process in FIG. 4 may be implemented in outsourcing modeler 116 in FIG. 1. For example, these different steps may be implemented using program code.

The process begins by identifying human resources data regarding employees of a set of benchmark organizations (step 410). The human resources data comprises employee name data and job type data. The process indexes the human resources data according to job type data (step 420).

The process determines a set of geographic distribution trends for each job type (step 430). The set of geographic distribution trends is determined based on the employee name data of the employees.

The process determines a competitive human resources migration model for the organization (step 440). The competitive human resources migration model is based on an effect of the set of geographic distribution trends on business metrics for the set of benchmark organizations.

The process digitally presents the competitive human resources migration model for the organization (step 450), with the process terminating thereafter.

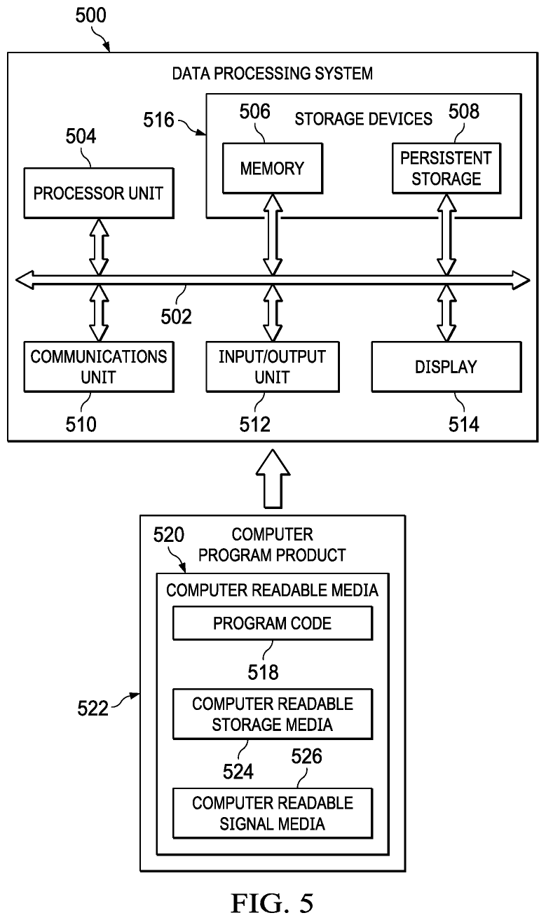

Turning now to FIG. 5, a block diagram of a data processing system is depicted in accordance with an illustrative embodiment. Data processing system 500 may be used to implement human resources modeling system 102, computer system 118, and other data processing systems that may be used in human resources migration environment 100 in FIG. 2. In this illustrative example, data processing system 500 includes communications framework 502, which provides communications between processor unit 504, memory 506, persistent storage 508, communications unit 510, input/output (I/O) unit 528, and display 514. In this example, communications framework 502 may take the form of a bus system.

Processor unit 504 serves to execute instructions for software that may be loaded into memory 506. Processor unit 504 may be a number of processors, a multi-processor core, or some other type of processor, depending on the particular implementation.

Memory 506 and persistent storage 508 are examples of storage devices 516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 516 may also be referred to as computer readable storage devices in these illustrative examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a solid state hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these illustrative examples, provides for communications with other data processing systems or devices. In these illustrative examples, communications unit 510 is a network interface card.

Input/output unit 512 allows for input and output of data with other devices that may be connected to data processing system 500. For example, input/output unit 512 may provide a connection for user input through at least one of a keyboard, a mouse, or some other suitable input device. Further, input/output unit 512 may send output to a printer. Display 514 provides a mechanism to display information to a user.

Instructions for at least one of the operating system, applications, or programs may be located in storage devices 516, which are in communication with processor unit 504 through communications framework 502. The processes of the different embodiments may be performed by processor unit 504 using computer-implemented instructions, which may be located in a memory, such as memory 506.

These instructions are referred to as program code, computer usable program code, or computer readable program code that may be read and executed by a processor in processor unit 504. The program code in the different embodiments may be embodied on different physical or computer readable storage media, such as memory 506 or persistent storage 508.

Program code 518 is located in a functional form on computer readable media 520 that is selectively removable and may be loaded onto or transferred to data processing system 500 for execution by processor unit 504. Program code 518 and computer readable media 520 form computer program product 522 in these illustrative examples. In one example, computer readable media 520 may be computer readable storage media 524 or computer readable signal media 526.

In these illustrative examples, computer readable storage media 524 is a physical or tangible storage device used to store program code 518 rather than a medium that propagates or transmits program code 518.

Alternatively, program code 518 may be transferred to data processing system 500 using computer readable signal media 526. Computer readable signal media 526 may be, for example, a propagated data signal containing program code 518. For example, computer readable signal media 526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running program code 518.

Thus, one or more of the illustrative examples provide a method and apparatus to overcome the complexities and time needed to determine a competitive human resources capital relocation strategy for an organization. One or more illustrative examples provide a technical solution that involves determining a competitive human resources migration model for an organization based on migration events of other benchmark organizations. Determining a competitive human resources migration model for an organization in this manner reduces the amount of time, effort, or both in the performance of operations for the organization.

The implementation of a human resources modeling system provides an ability to implement a competitive human resources capital relocation strategy for the organization more easily as compared to current systems. For example, the different relocation events of different organizations can be captured and translated into effects on business metrics. When a competitive human resources migration model is determined in this manner, the competitive human resources migration model may be relied upon to perform operations for an organization. The operations can be performed in a manner that is consistent with migration events of benchmark organizations based on changes in business metrics attributed to migration events of those benchmark organizations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally presenting a competitive human resources migration model for an organization, the method comprising:
identifying, by a computer system, human resources data regarding employees of a set of benchmark organizations, wherein the human resources data comprises employee name data and job type data;
indexing, by the computer system, the human resources data according to the job type data;
determining, by the computer system, a set of geographic distribution trends for each job type, wherein the set of geographic distribution trends is determined based on the surname data of the employees;
determining, by the computer system, a competitive human resources migration model for the organization based on an effect of the set of geographic distribution trends on business metrics for a set of benchmark organizations; and
digitally presenting, by the computer system, the competitive human resources migration model for the organization.

2. The method of claim 1, wherein determining the set of geographic distribution trends for each job type comprises:
predicting, by the computer system, a set of geographic locations for each job type based on the employee name data of the employees of the set of benchmark organizations.

3. The method of claim 2, wherein predicting the set of outsourced geographic locations further comprises:
identifying, by the computer system, a set of geographic origin statistics for each employee name;
aggregating, by the computer system, the set of geographic origin statistics within each job type; and
predicting, by the computer system, the set of outsourced geographic locations for the job type based on the aggregated origin statistics for the job type.

4. The method of claim 1, wherein determining the set of geographic distribution trends for each job type comprises:
identifying, by the computer system, human resources data that indicates a first number of employees for the benchmark organizations that migrate into the set of geographic locations over a time period;
identifying, by the computer system, human resources data that indicates a second number of employees for the benchmark organizations that migrate away from the set of geographic locations over the time period; and
determining, by the computer system, a net migration of employees for the benchmark organizations in the set of geographic locations over the time period.

5. The method of claim 1, further comprising:
determining, by the computer system, the effect of the set of geographic distribution trends on the business metrics for a set of benchmark organizations;
wherein the business metrics for the benchmark organizations are correlated with the set of geographic distribution trends using a correlation policy, wherein the correlation policy is selected a group of policies consisting of a descriptive statistics policy, a linear regression policy, a vector auto-regression policy, an impulse response function policy, and combinations thereof.

6. The method of claim 1, wherein the effect on the business metrics comprises:
a change in a stock price of the benchmark organizations;
a change in a revenue of the benchmark organizations;
a change in operating expenses of the benchmark organizations; and
a change in a gross profit of the benchmark organizations.

7. The method of claim 1, further comprising:
performing an operation for the organization based on the competitive human resources migration model for the organization, wherein the operation is enabled based on the competitive human resources migration model.

8. The method of claim 7, wherein the operation is selected from relocation operations, hiring operations, benefits administration operations, payroll operations, performance review operations, forming teams for new products, and assigning research projects.

9. A computer system comprising:
a hardware processor;
a display system; and
an outsourcing modeler in communication with the hardware processor and the display system, wherein the outsourcing modeler:
identifies human resources data regarding employees of a set of benchmark organizations, wherein the human resources data comprises employee name data and job type data;
indexes the human resources data according to the job type data;
determines a set of geographic distribution trends for each job type, wherein the set of geographic distribution trends is determined based on the surname data of the employees;
determines a competitive human resources migration model for the organization based on an effect of the set of geographic distribution trends on business metrics for a set of benchmark organizations; and
digitally presents the competitive human resources migration model for the organization.

10. The computer system of claim 9, wherein in determining the set of geographic distribution trends for each job type, the outsourcing modeler further:
predicts a set of geographic locations for each job type based on the s employee name data of the employees of the set of benchmark organizations.

11. The computer system of claim 10, wherein in predicting the set of outsourced geographic location, the outsourcing modeler further:
identifies a set of geographic origin statistics for each employee name;
aggregates the set of geographic origin statistics within each job type; and
predicts the set of outsourced geographic locations for the job type based on the aggregated origin statistics for the job type.

12. The computer system of claim 9, wherein in determining the set of geographic distribution trends for each job type, the outsourcing modeler further:
identifies human resources data that indicates a first number of employees for the benchmark organizations that migrate into the set of geographic locations over a time period;
identifies human resources data that indicates a second number of employees for the benchmark organizations that migrate away from the set of geographic locations over the time period; and
determines a net migration of employees for the benchmark organizations in the set of geographic locations over the time period.

13. The computer system of claim 9, wherein the outsourcing modeler further:
determines the effect of the set of geographic distribution trends on the business metrics for a set of benchmark organizations;
wherein the business metrics for the benchmark organizations are correlated with the set of geographic distribution trends using a correlation policy, wherein the correlation policy is selected a group of policies consisting of a descriptive statistics policy, a linear regression policy, a vector auto-regression policy, an impulse response function policy, and combinations thereof.

14. The computer system of claim 9, wherein the effect on the business metrics comprises:
a change in a stock price of the benchmark organizations;
a change in a revenue of the benchmark organizations;
a change in operating expenses of the benchmark organizations; and
a change in a gross profit of the benchmark organizations.

15. The computer system of claim 9, wherein the computer system further:
performs an operation for the organization based on the competitive human resources migration model for the organization, wherein the operation is enabled based on the competitive human resources migration model.

16. The computer system of claim 15, wherein the operation is selected from relocation operations, hiring operations, benefits administration operations, payroll operations, performance review operations, forming teams for new products, and assigning research projects.

17. A computer program product for digitally presenting a competitive human resources migration model for an organization, the computer program product comprising:
a non-transitory computer readable storage medium;
program code, stored on the computer readable storage medium, for identifying human resources data regarding employees of a set of benchmark organizations, wherein the human resources data comprises employee name data and job type data;
program code, stored on the computer readable storage medium, for indexing the human resources data according to the job type data;
program code, stored on the computer readable storage medium, for determining a set of geographic distribution trends for each job type, wherein the set of geographic distribution trends is determined based on the surname data of the employees;
program code, stored on the computer readable storage medium, for determining a competitive human resources migration model for the organization based on an effect of the set of geographic distribution trends on business metrics for a set of benchmark organizations; and
program code, stored on the computer readable storage medium, for digitally presenting the competitive human resources migration model for the organization.

18. The computer program product of claim 17, wherein the program code for determining the set of geographic distribution trends for each job type comprises:
program code, stored on the computer readable storage medium, for predicting a set of geographic locations for each job type based on the s employee name data of the employees of the set of benchmark organizations.

19. The computer program product of claim 18, wherein the program code for predicting the set of outsourced geographic locations further comprises:
program code, stored on the computer readable storage medium, for identifying a set of geographic origin statistics for each employee name;
program code, stored on the computer readable storage medium, for aggregating the set of geographic origin statistics within each job type; and
program code, stored on the computer readable storage medium, for predicting the set of outsourced geographic locations for the job type based on the aggregated origin statistics for the job type.

20. The computer program product of claim 17, wherein the program code for determining the set of geographic distribution trends for each job type comprises:
program code, stored on the computer readable storage medium, for identifying human resources data that indicates a first number of employees for the benchmark organizations that migrate into the set of geographic locations over a time period;
program code, stored on the computer readable storage medium, for identifying human resources data that indicates a second number of employees for the benchmark organizations that migrate away from the set of geographic locations over the time period; and
program code, stored on the computer readable storage medium, for determining a net migration of employees for the benchmark organizations in the set of geographic locations over the time period.

21. The computer program product of claim 17, further comprising:
program code, stored on the computer readable storage medium, for determining the effect of the set of geographic distribution trends on the business metrics for a set of benchmark organizations;
wherein the business metrics for the benchmark organizations are correlated with the set of geographic distribution trends using a correlation policy, wherein the correlation policy is selected a group of policies consisting of a descriptive statistics policy, a linear regression policy, a vector auto-regression policy, an impulse response function policy, and combinations thereof.

22. The computer program product of claim 17, wherein the effect on the business metrics comprises:
a change in a stock price of the benchmark organizations;
a change in a revenue of the benchmark organizations;
a change in operating expenses of the benchmark organizations; and
a change in a gross profit of the benchmark organizations.

23. The computer program product of claim 17, further comprising:
program code, stored on the computer readable storage medium, for performing an operation for the organization based on the competitive human resources migration model for the organization, wherein the operation is enabled based on the competitive human resources migration model.

24. The computer program product of claim 23, wherein the operation is selected from relocation operations, hiring operations, benefits administration operations, payroll operations, performance review operations, forming teams for new products, and assigning research projects.
